(19) United States
(12) Patent Application Publication
(10) Pub. No.: US 2014/0214319 A1
(43) Pub. Date: Jul. 31, 2014

(54) Computer System and Method for Search of a Parking Spot

(71) Applicant: Parkwayz, Inc., Philadelphia, PA (US)

(72) Inventors: Slobodan Vucetic, Philadelphia, PA (US); Mihajlo Grbovic, Mountain View, CA (US); Nemanja Djuric, Philadelphia, PA (US)

(73) Assignee: Parkwayz, Inc., Philadelphia, PA (US)

(21) Appl. No.: 14/163,965

(22) Filed: Jan. 24, 2014

Related U.S. Application Data
(60) Provisional application No. 61/756,836, filed on Jan. 25, 2013.

(51) Int. Cl. G01C 21/34

(52) U.S. Cl. CPC G01C 21/3407
USPC 701/533; 701/400; 701/537; 701/540

(57) ABSTRACT

Embodiments of the invention comprise a computer system and a method for recommending a driving route that reduces parking search time and parking costs. The system is configured to receive information about a current location of a car, a desired destination, and parking preferences, to process this information together with available traffic and parking information in order to calculate a recommended route a car should follow during a parking search, and to communicate the recommended route to the car driver. The driver is instructed to park at the first available spot along selected portions of the recommended route.

This application claims the benefit of U.S. Provisional Application 61/756,836, filed on Jan. 25, 2013, which is hereby incorporated herein by reference, in its entirety.

### FIELD OF THE INVENTION

The field of the invention relates to traffic routing and route planning, and more specifically to recommending a driving route a car should follow while searching for a parking spot that results in fast and cheap parking.

### BACKGROUND OF THE INVENTION

Parking search has become a major issue in urban areas. Parking search could create a stressful experience for a driver, particularly if the driver is not familiar with the area. Routes that drivers choose to follow may be very inefficient, which may result in loss of their time and money as well as cause or increase traffic congestion. The results of a 2011 IBM Global Parking Survey conducted in 20 international cities shows that around 30 percent of traffic in major cities is caused by drivers searching for a parking spot, that nearly six out of 10 drivers have abandoned their search for a space at least once, and that over half of all drivers in 16 of the 20 cities reported that they have been frustrated enough that they gave up looking for a parking space and as a result did not reach their intended destination.

In traditional navigation systems, given the current location of a car and a desired destination, the driver is recommended a fast or low-cost route from the current location to the destination. A problem with the traditional navigation is that the route ends at the destination, regardless of whether the car can be parked there or not. As a result, upon arriving at the destination, the driver is often forced to begin a search for a parking spot, typically without any support from the navigation system beyond displaying a map of the neighborhood of the destination.

There are several recent efforts to help drivers in parking search beyond what the traditional navigation systems provide. One approach relies on displaying parking-related information to drivers to aid their parking search process. Some systems and services overlay the maps with static information about on-street parking spots and off-street parking garages, such as parking locations, rules, and prices. For example, U.S. Pat. No. 8,175,803 (Caraballo) describes a graphic interface method for providing parking information in the vicinity of the destination, particularly with respect to parking rules. There are also several existing companies that provide navigation systems that display annotated maps with information about locations, pricing, and parking rules of parking garages.

Some systems, used in parking garages, provide real-time information about availability of parking spots. Providing real-time parking availability typically necessitates installation of a sensing system. For example, many parking garages have sensing systems that provide real-time information about parking availability such as a total number of available parking spots in the garage or a number of available spots in each garage segment. If the total number of available spots is desired, the sensing systems usually consist of counters mounted on entrance and exit garage ramps. Measuring parking availability at different garage segments requires installation of appropriate counters at entrances and exits for each of the segments. For on-street parking, several cities have been installing sensors at individual parking spots to collect real-time information about parking availability. For example, the San Francisco Park project recently installed parking sensors at each parking spot across a number of city blocks and is providing real-time parking occupancy and pricing information to the public through their internet portal.

Some systems attempt to provide real-time or historical parking information without having to install a sensing infrastructure. For example, U.S. Pat. No. 7,936,284 (Levine et al.) uses crowdsourced movement trajectories of cars to detect when they begin the parking search process and then to estimate the time needed for parking. By accumulation of the estimated parking times, the system may provide information about typical parking search times at different locations and at different times of day or week, which can be useful for trip planning Crowdsourced movement trajectories are a low-cost source of traffic information, but it is still an open question how to analyze trajectories to obtain useful parking-related information. For example, crowdsourced parking search trajectories may come both from experienced drivers knowledgeable about traffic and parking patterns in the area around a destination and from novice drivers without any knowledge about the traffic and parking patterns. As a result, parking search behavior of different drivers might be vastly different and it may complicate analysis of the collected moving trajectories.

Users of the navigation systems whose maps are enhanced with parking-related information are expected to decide where to park based on a visual inspection of the map. A problem with this approach is that drivers might be overwhelmed by or unable to utilize the displayed information in a way that results in fast and cheap parking.

In addition to providing parking-related information, some systems also help drivers to select a particular available parking spot and provide driving directions to the selected parking spot. For example, U.S. Published Patent Application No. 2012/0056758 (Kuhlman et al.) describes a system for locating open parking spots and recommending the spot closest to the destination. One problem with this solution is that it requires installation and maintenance of a costly sensing infrastructure to detect the available parking spots. Another problem is that, even if information about occupancy of individual parking spots is available and accurate, recommending a particular parking spot that is currently available is risky because the spot might become occupied by the time the driver arrives there, thus forcing the driver to initiate a new parking search. Having to repeat the parking spot search can result in a costly and frustrating parking experience. To address this issue, in U.S. Pat. No. 7,538,690 (Kaplan et al.) and U.S. Published Patent Application 2010/0042318 (Kaplan et al.) a method is described that, in addition to identifying the best parking garage near the destination based on historical availability and providing a route to it, can also reserve the selected spot. This approach is reasonable for parking garages because the garages can develop parking reservation systems in a relatively straightforward way. However, it would be hard to implement the same system for on-street parking. First, even the best on-street parking monitoring systems are not 100% accurate. Therefore, it is not possible to know the status of any on-street parking spot with certainty. Second, it would be cumbersome or costly to guarantee reservation of available on-street parking spots and prevent others from parking at those spots.

Several methods were proposed recently that go beyond guiding a driver to a selected spot that is currently vacant. In U.S. Published Patent Application 2008/0048885 (Quinn), a method is described that starts by estimating probabilities of finding a vacancy at a parking space at the estimated time of arrival at the space. Using these probabilities, the parking spaces are ranked according to the most quickly or easily accessible space. The ranking is provided to assist the user in selecting an order of spaces in which to seek a vacancy. A deficiency of this navigation assistance is that the search can become very inefficient if the user does not find vacancy at the top ranked spot. In U.S. Published Patent Application 2012/0161984 (Amir), an optimization-based method is proposed to provide a recommended path for a parking search. Using the probabilities of vacancy along multiple street segments within the region of interest and parking preferences of a user, the method finds the path with the highest expected reward. Given the recommended path, the user is expected to park at the first vacant parking spot along the path. A deficiency of such approach is that parking at the first available spot along the recommended route might result in an undesirable outcome, for example, in cases when the current location of the car is far from the destination and there is a large probability of vacancy at the destination. U.S. Published Patent Application 2009/0171567 (Morimoto et al.) proposes a method that calculates a path from the current location to the destination, such that the route passes next to at least one on-street parking zone, where such one or more parking zones are highlighted on display and a user is encouraged to seek vacant parking spots within the highlighted parking zones. A deficiency of this approach is that the recommended path ends at the destination and it is not clear what should happen if a user does not find a vacant parking spot within the highlighted parking zones. U.S. Pat. No. 7,936,284 (Levine et al.) discloses that the accumulated parking search times could be used to provide a preferred path of searching or location of a preferred parking spot, but it fails to define the preferred parking paths or spots and it does not explain how the recommendations may be calculated.

Thus there is a need for a system for parking recommendations that addresses weaknesses of the existing systems. A system for search of a parking spot according to a preferred embodiment of the invention uses available parking-related information, including data collected by the system, information coming from the existing sensor systems, and crowdsourced data, to recommend a driving route that a car should follow. The system also specifies along which segments to seek parking spots in order to find a parking spot quickly and with low cost. The system does not require installation of sensing infrastructure, has the ability to utilize all the available information in a consistent manner, and is able to improve over time. The system can be customized to account for specific parking preferences of drivers, such as parking duration, time flexibility, and price elasticity.

### SUMMARY OF THE INVENTION

A computer system and a method for search of a parking spot are described. In an embodiment, the system obtains parking instructions for a vehicle that is seeking a parking spot, where the instructions may provide information about the current vehicle location, location of destination, and parking preferences such as parking duration, time flexibility, price elasticity, and desire to walk. The system of an embodiment uses the parking instructions to recommend a parking search route for said vehicle. The parking search route comprises a sequence of consecutive road segments beginning at the current location of the vehicle. In addition, the system of an embodiment designates a fraction of segments along the parking search route for parking. The vehicle is instructed to follow the recommended parking search route and park at the first available parking spot along the specifically designated segments of the route. The recommended parking search route is communicated to the operator of the vehicle, whether it is a human operator or driving software. To recommend the parking search route the system of an embodiment uses parking information that may contain road network, traffic rules, parking rules, estimates of traffic speed, and estimates of parking probabilities in the vicinity of the destination. The system of an embodiment may calculate the recommended parking search route in numerous ways. A preferred method is to recommend the route which has the largest expected parking reward, where parking reward may be defined as a function of time and effort to reach the destination and monetary costs of parking.

### BRIEF DESCRIPTION OF THE DRAWINGS

FIG. 1 shows a schematic illustration of the parking recommendation system according to a preferred client-server embodiment of the present invention.

FIG. 2 shows an exemplary client device of an embodiment of the invention.

FIG. 3 shows an exemplary remote server of an embodiment of the invention.

FIG. 4 shows a flowchart that explains a process for requesting and obtaining a parking search route by client device, according to an embodiment of the invention.

FIG. 5 illustrates how a recommended parking search route may be displayed to a driver in one embodiment of the present invention.

FIG. 6 illustrates a potential outcome of a parking search using the parking recommendation system.

FIG. 7 shows a flowchart that describes the process for calculating a parking search route by a server, according to an embodiment of the invention.

FIG. 8 illustrates two examples of reward functions, in accordance with embodiments of the invention.

### DETAILED DESCRIPTION OF THE PREFERRED EMBODIMENTS

Preferred embodiments of the present invention provide a solution for car parking and include a computer system and a method for recommending a driving route that reduces the time and cost of finding a parking spot. Embodiments of the present invention relate to recommending a parking search route.

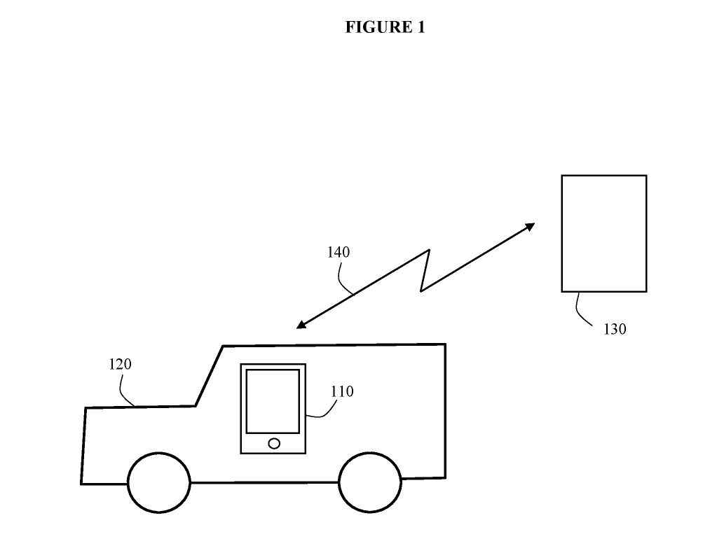

FIG. 1 is a schematic illustration of a system for recommendation of a parking search route according to an exemplary embodiment of the present invention. The system in FIG. 1 comprises a client device 110 available to the driver or a passenger of a car 120, a remote server 130, and a communication channel 140 between client device 110 and remote server 130. In the following discussion, the term “the driver” refers either to the driver of car 120 or to any passenger of car 120 that uses client device 110 and can communicate with the driver during the parking search.

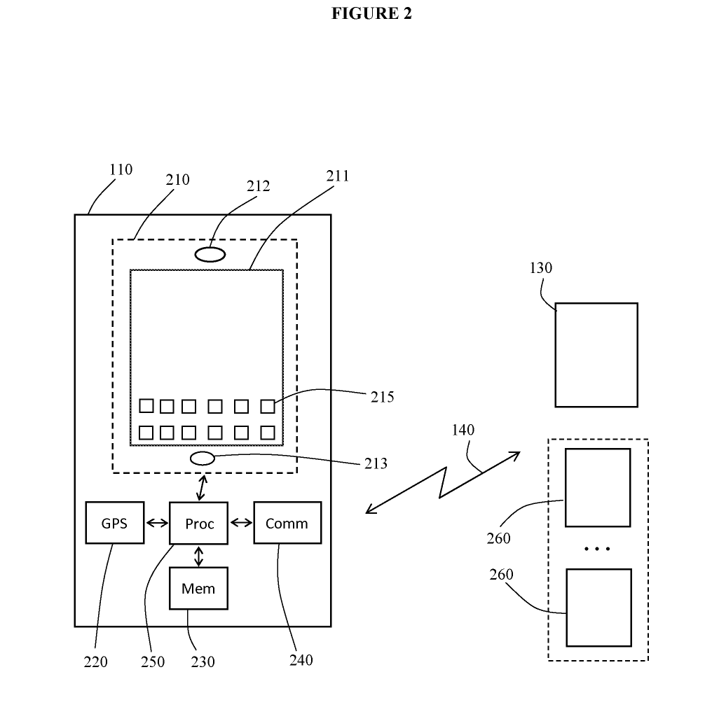

In a preferred embodiment, client device 110 has input and output capabilities that allow the driver to enter parking instructions and receive parking recommendations and other relevant information. It also has communication capabilities with remote server 130 through communication channel 140. FIG. 2 shows an exemplary client device 110. Client device 110 may contain a user interface 210 comprising a multi-touch display 211, a speaker 212, and a microphone 213. Multi-touch display 211 may display a map, a parking search route, and other relevant information, and may also receive parking instructions from the driver, such as through a virtual keyboard 215. The driver may manually enter parking instructions, such as through virtual keyboard 215 or microphone 213. In addition to showing information on display 211, client device 110 may also provide voice messages through speaker 212. Client device 110 may have a location-sensing component 220 through which it may estimate the current location of car 120 and its driving direction, such as a global positioning system (GPS) sensor. In addition, client device 110 may have a memory 230 and a communication interface 240 that allows it to communicate through communication channel 140 with remote server 130 and with a plurality of third-party remote servers 260. Device 110 may also have a processing unit 250 that manages all operations of client device 110 and is connected to user interface 210, location-sensing component 220, memory 230, and communication interface 240.

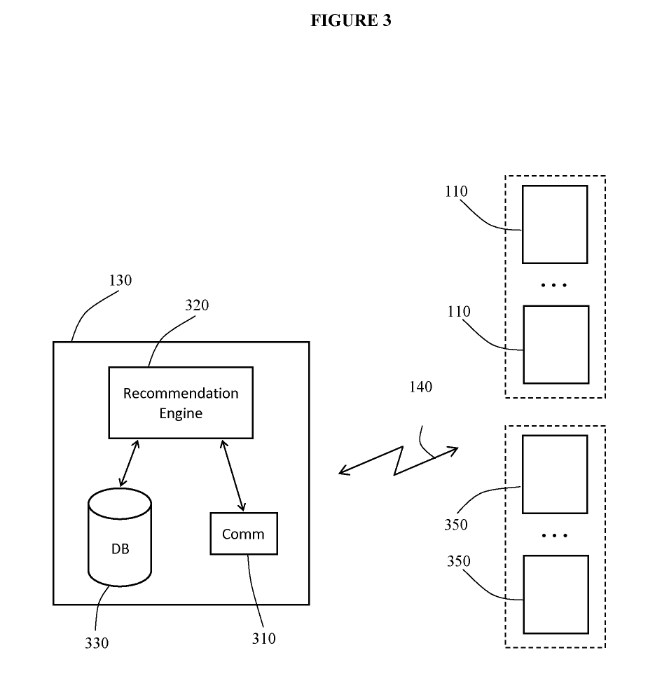

In the exemplary embodiment illustrated in FIG. 3, remote server 130 may have a communication interface 310 that allows it to communicate through communication channel 140 with client device 110. Remote server 130 may be linked to a plurality of client devices 110 requiring parking recommendations and to a plurality of third-party remote servers 350. Remote server 130 contains a recommendation engine 320 responsible for calculating a recommended parking search route based on parking instructions received from client device 110 through communication interface 310. Recommendation engine 320 may retrieve necessary information for calculating parking recommendations from a parking database 330 or from the third-party remote servers 350.

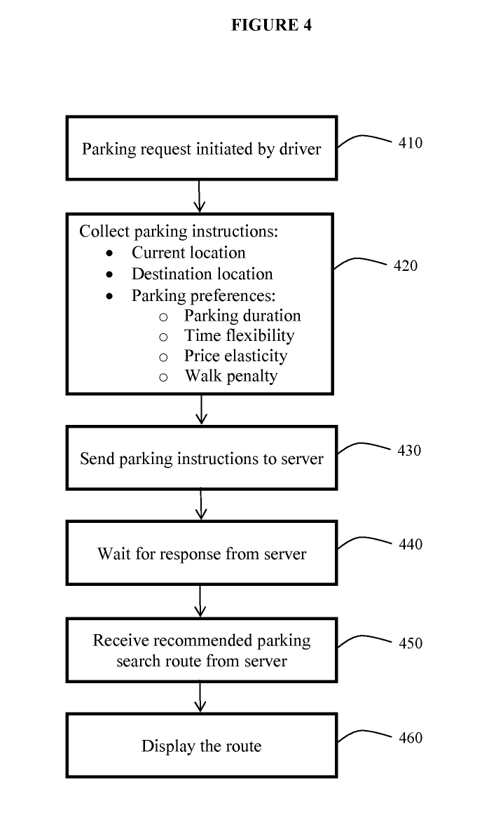

Reference is now made to FIG. 4, which is a flowchart describing a process for requesting and obtaining a parking search route performed by client device 110 in this exemplary embodiment. The process starts with the driver initiating the parking request through client device 110, which then collects the parking instructions and sends them to remote server 130. The parking instructions may comprise the current location and driving direction of car 120, the location of a desired destination, a duration of parking, and parking preferences.

FIG. 4 shows a flowchart that explains a process for requesting and obtaining a parking search route by client device 110 in this exemplary embodiment. In step 410, the process starts with the driver initiating the parking request through client device 110. In step 420 parking instructions are collected by client device 110. The parking instructions may comprise the current location and driving direction of car 120, the location of a desired destination, and parking preferences. The current location and the driving direction may be obtained from location-sensing component 220 or may be entered manually by the driver, such as through virtual keyboard 215, through microphone 213, or by pointing at or selecting a location on a map shown on multi-touch display 211. The desired destination may be entered by the driver through virtual keyboard 215, through microphone 213, by pointing at or selecting a location on a map shown on multi-touch display 211, or by any other interaction with multi-touch display 211, for example, by using a drop-down menu of points of interest and favorite locations. The client device 110 may allow for a default option where the desired destination is not entered by the driver, but is instead assumed to be the same as the current location. The parking preferences may include information about desired parking duration, which may be entered manually by the driver, or assumed to be a default value. The parking preferences may also include a set of factors that describe what kind of parking spot is preferred, for example, time flexibility, price elasticity, and walk penalty of the driver. The time flexibility refers to importance of reaching the destination by certain time, for example, by 8 pm. For example, the time flexibility is low for a driver with a ticket to a concert starting at 8 pm, while it is high for a driver intent on joining friends in a bar around 8 pm. The price elasticity refers to willingness of a driver to pay for reaching the destination faster. For example, while the concert-going driver might be willing to pay 20 dollars for valet parking to ensure making the concert on time, the bar-going driver might be content to lose a few more minutes on a parking search to find a cheap or free on-street parking spot. The walk penalty refers to willingness of a driver to park far from the destination. For example, the walk penalty can be high during a rainy or a snowy day. In a preferred embodiment, as will be elaborated later, the parking preferences may be converted into a reward function and conveniently used by recommendation engine 320 of remote server 130 to calculate a recommended parking search route. The parking preferences may be provided by the driver or assumed to be default values.

In step 430, parking instructions are sent to remote server 130 through communication channel 140. In step 440, client device 110 is waiting for recommendation engine 320 of remote server 130 to calculate the recommended parking search route. The parking search route of an embodiment is defined as a sequence of M consecutive road segments starting from the current location, where each segment is labeled either as PARK or NO_PARK. Value M may be as large as desired and may be set to an appropriate number, for example, to make sure that the route has a length of at least 10 city blocks. In step 450, client device 110 receives the recommended parking search route from remote server 130 through communication channel 140. In step 460, upon receiving the route, client device 110 communicates it to the driver. In an exemplary embodiment, the route is overlayed on a map and shown on multi-touch display 211. Information needed to display the map may be residing on client device 110, or may be obtained from remote server 130, or from a third-party server 260. There are numerous other ways how the recommended parking search route may be communicated to the driver through display 211 or through speaker 212, for example, as turn-by-turn directions. Using the recommended parking search route, the driver is instructed to drive along the parking search route and to park at the first available parking spot along the road segments labeled with PARK.

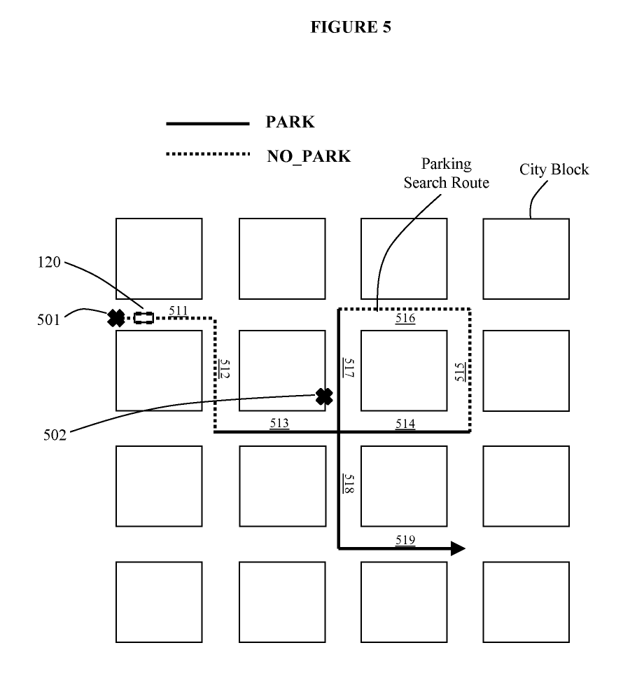

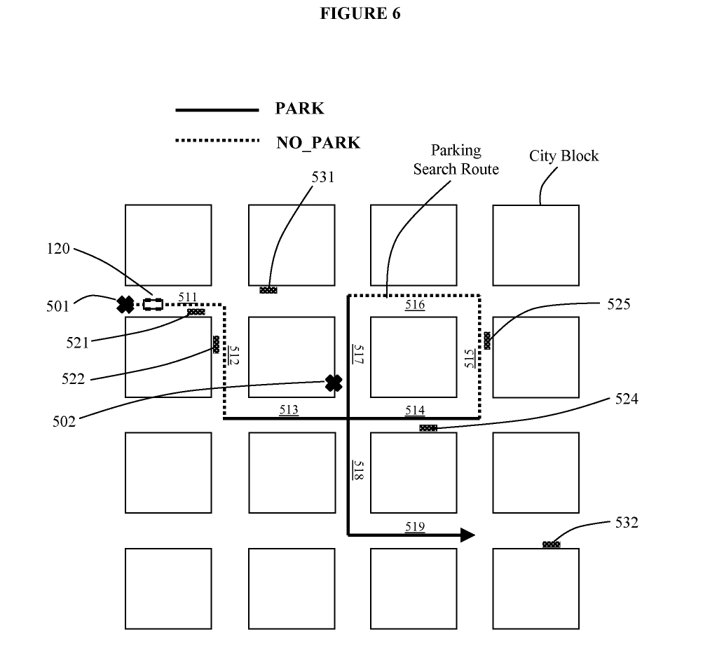

FIG. 5 illustrates how a recommended parking search route may be displayed to the driver in one embodiment of the present invention. In FIG. 5, the driver of car 120 made parking request when car 120 was at location 501 and was interested in reaching a destination 502. The recommended parking search route obtained from remote server 130 has M=9 segments, with segment IDs ranging from 511 to 519, where each segment is either a PARK or a NO_PARK. The route is displayed on multi-touch display 211 of client device 110. The route is overlaid on a map that shows a region covering 16 city blocks. In the display, the segments of the route with a full line are denoted as PARK and the segments with a dashed line are denoted as NO_PARK. FIG. 6 illustrates a potential outcome of this particular parking search, where it is assumed that the only currently available parking spots in the region covered by the display are at locations 521, 522, 524, 525, 531, and 532. In the example shown in FIG. 6, the driver of car 120 would start driving from current location 501 along segment 511. Because segment 511 is a NO_PARK segment, the driver would continue driving along the route although there is an available parking spot 521 within the segment. Next, the driver would drive along NO_PARK segment 512, again without looking for a parking spot. Upon reaching segment 513, the driver would start looking for a parking spot. Since there is no available parking spot along segment 513, the driver would continue driving along PARK segment 514, still looking for a parking spot. The driver would see the available parking spot 524 and park car 120 there. After parking car 120, the driver would pay a parking fee, if necessary, and then walk toward destination 502.

The choice of M influences computational time to calculate the recommended route. While M can be set arbitrarily large, in some embodiments it might be desirable to set M to a relatively small number, such as M=10 or M=15. In such embodiments, the process for requesting and obtaining a parking search route by client device 110 described in FIG. 4 may be repeated until a parking spot is found. For example, client device 110 may continue to record its current location periodically, for example, every 10 seconds or every 50 meters. If client device 110 determines that car 120 traveled more than a certain distance, for example M/2 segments, and did not find a parking spot, it may send a new request to remote server 130 for a parking search route starting from the current location of car 120. Upon receipt of the new route from remote server 130, client device 110 may refresh its display 211 by replacing the old recommended parking search route with the new one. In other embodiments, the new request may be initiated by the driver or by server 130.

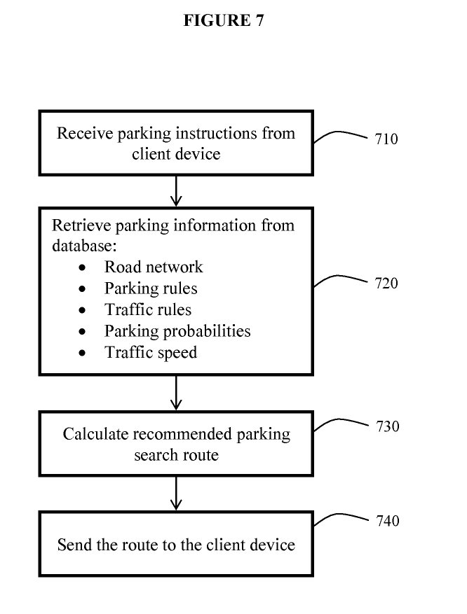

FIG. 7 shows a flowchart that describes a process for calculating a parking search route performed by remote server 130 in an embodiment. In step 710, remote server 130 receives parking instructions from client device 110 through communication channel 140. The instructions are then passed to recommendation engine 320 of remote server 130. In step 720, recommendation engine 320 further queries parking database 330 to retrieve parking information relevant for calculation of a parking search route. This information may include road network, parking rules, and traffic rules in the vicinity of the destination. Parking information may also include data related to historical and/or current and/or future predicted traffic speeds and probabilities of finding an available parking spot on all road segments in the vicinity of the destination. The vicinity of the destination can be defined as all road segments within an appropriate distance from the destination, for example, within 2 kilometers. The road network may contain information about location and shape of road segments and how the segments are connected. The parking rules may contain information about allowed duration of parking and parking prices at different times of the day and on different days, as well as parking restrictions, such as handicapped parking or loading zones. The traffic rules may contain information about allowed directions of traffic, such as one-way streets or forbidden left turns. In some embodiments, some of the parking information may be obtained from third-party remote servers 350 instead from parking database 330. In step 730, given the parking instructions obtained from client device 110 and parking and traffic information obtained from parking database 330 or from third-party remote servers 350, recommendation engine 320 calculates the parking search route, as discussed in further detail below. In step 740, remote server 130 sends the route to client device 110.

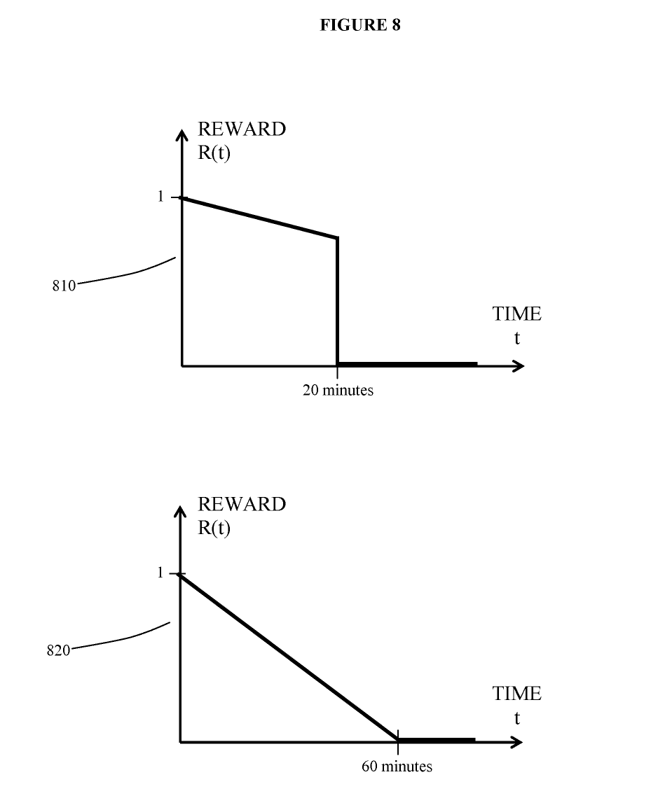

To calculate a parking search route, in a preferred embodiment, recommendation engine 320 relies on a reward function R(t) that quantifies satisfaction of the driver with parking and reaching the destination from the current location in t minutes. FIG. 8 illustrates two possible reward functions. The reward function 810 at the top of FIG. 8 has the maximum value 1 when t=0 and then decreases slowly until t=20 minutes. At t=20 minutes, it decreases sharply to zero. This reward function may correspond to a driver who must reach the destination within 20 minutes because of an important meeting. The reward function 820 at the bottom of FIG. 8 has the largest value 1 when t=0 and then decreases linearly toward zero and reaches zero at t=60 minutes. This reward function may correspond to a driver who prefers to reach the destination quickly, but can tolerate delays. A designer of the system may have flexibility in deciding what reward functions are appropriate for different types of parking preferences and how recommendation engine 320 should convert the specific parking instructions obtained by client device 110 to the reward function. For example, while it might be preferable that the reward function never increases with time, a designer of the system might decide otherwise. In one particular embodiment, client device 110 may offer to the driver a selection of 2 buttons on multi-touch display 211, where the first is titled “Flexible” and the second “Deadline”. If the driver selects “Flexible”, the reward curve 820 from the bottom of FIG. 8 may be used by recommendation engine 320. If the driver selects “Deadline”, the driver may then be asked to enter what is the latest acceptable arrival time and then a reward function such as the function 810 at the top of FIG. 8 may be used by recommendation engine 320. In other embodiments, a default reward function may be used for all drivers, for example, the reward function at the bottom of FIG. 8. In this case, the driver would not need to enter any parking preferences to client device 110.

Once the reward function R(t) is determined by recommendation engine 320, it becomes possible to calculate the reward of parking at any particular parking spot. Let us consider an example from FIG. 6, where the driver started from location 501, drove along segments 511, 512, 513 and 514, parked at spot 524 within segment 514, and walked to destination 502. The reward for parking at spot 524 on segment 514 may be calculated as R(T_{d}(501,524)+T_{w}(524,502)), where T_{d}(501,524) is actual driving time by car 120 from current location 501 to parking spot 524 along route consisting of segments 511, 512, 513 and 514, and T_{w}(524,502) is the walking time, defined as the total time spent by the driver from parking car 120 at parking spot 524 to reaching destination 502. Numerous modifications of this formula may be possible in alternative embodiments. In some embodiments, for example, the reward may be calculated as R(T_{d}(501,524)+w₁*T_{w}(524,502)), where w₁ is a number larger than one, reflecting that the driver prefers to find a parking spot close to the destination even if it requires slightly longer total time to reach the destination from the current location. It is also possible to account for the price elasticity of the driver. In some embodiments, for example, reward may be calculated as R(T_{d}(501,524)+w₁*T_{w}(524,502)+w₂*price), where price is the price of parking and w₂ is a positive number, thus reflecting that the reward drops with the price of parking. For example, w₂=1 reflects that the driver is willing to pay one more dollar for parking if the destination could be reached one minute earlier. In some embodiments, the system may use more elaborate ways to calculate the reward. For example, the reward function may be defined as some non-increasing function of parking search time and price, which may also depend on the time when the parking search is initiated, t search, and weather conditions, weather, such that said reward function can be represented as R(t, price, t search, weather).

Given a formula to calculate the reward for parking at a specific parking spot, it becomes possible for recommendation engine 320 to predict the reward of any given parking search route, to compare the rewards of two routes, and to find the best route. Prediction of the reward for a recommended route may be subject to many uncertainties. For example, even if the recommendation engine 320 knows with certainty that car 120 will start from origin, park at parking spot along the recommended route, and that the driver will then walk to destination, time T_{d}(origin, parking_spot) depends on actual traffic speed along the route and time T_{w}(parking_spot, destination) depends on how long it will take the driver to pay for the parking and leave the parking facility, how fast the driver walks, how crowded the streets are, and what the traffic light patterns are along the walking path to the destination. As a result, recommendation engine 320 may treat driving and walking times as random variables that have to be statistically estimated. For example, recommendation engine 320 may predict driving and walking time for each road segment along the route based on statistical analysis of previous parking searches by users of the system which are stored in database 330 or based on information obtained from third-party servers. In addition to uncertainties in driving and walking times, it may not be possible to know with certainty on which road segment along the route the parking spots will be available. As a result, recommendation engine 320 may estimate for each road segment along the route the parking probability, defined as probability of finding an available parking spot along the segment. The parking probabilities may be estimated using historical data collected from the users of the system and stored in database 330 or based on information obtained from third-party servers. Given estimates of driving time, walking time, and parking probability along every segment of a route, recommendation engine 320 may calculate the expected reward for the given parking search route.

To explain more precisely how recommendation engine 320 may calculate the expected reward of a route in the preferred embodiment, we need to introduce some mathematical notation. Let us represent the unique identifiers (IDs) of road segments along a specific route of length M as a sequence {i₁, i₂, . . . , i_{M}}. Then, let us define as {park₁, park₂, . . . , park_{M}} the corresponding binary parking indicators of whether the driver should look for a parking spot along each of the route segments, where parkₘ=1 means that the m-th segment along the route with ID iₘ is PARK and parkₘ=0 means that the segment is NO_PARK segment. The lower bound on the expected reward of this route may be expressed as the following recursive formula:

$${R}_{lower} ( \{ {i}_{1} , {i}_{2} , … , {i}_{M} \} , \{ {park}_{1} , {park}_{2} , … , {park}_{M} \} ) = {R}_{lower} ( \{ {i}_{1} , {i}_{2} , … , {i}_{M - 1} \} , \{ {park}_{1} , {park}_{2} , … , {park}_{M - 1} \} ) + p ( {i}_{M} ) \cdot {park}_{M} \cdot R ( {T}_{d} ( \{ {i}_{1} , {i}_{2} , … , {i}_{M} \} ) + {T}_{w} ( {i}_{M} , destination ) ) \cdot {\prod }_{m = 1}^{M - 1} ( 1 - p ( {i}_{m} ) \cdot {park}_{m} ) \qquad ( Equation 1 )$$

where p(i_{M}) is the parking probability for road segment i_{M}, T_{d}({i₁, i₂, . . . , i_{M}}) is estimated driving time to traverse route {i₁, i₂, . . . , i_{M}}, and T_{w}(i_{M},destination) is estimated walking time to reach the destination after parking at road segment with ID i_{M}. The term R(T_{d}({i₁, i₂, . . . , i_{M}})+T_{w}(i_{M},destination)) is the reward of parking at the M-th segment, which is a function of the total time to reach the destination equal to sum of parking search time T_{d}({i₁, i₂, . . . , i_{M}}) and walking time T_{w}(i_{M},destination). The term

$${\prod }_{m = 1}^{M - 1} ( 1 - p ( {i}_{m} ) \cdot {park}_{m} )$$

is the probability that the user reaches the M-th segment by car, which equals probability that the user did not park along the first M−1 segments. The term p(i_{M})·park_{M} is the probability that the user would find parking along the M-th segment. The recursive formula is a sum of the expected reward if parking is found along the first M−1 segments and the expected reward if parking is found along the M-th segment. The formula is a lower bound on the expected reward because it assumes that if parking is not found along the first M segments of the route, the reward of the subsequent parking search is zero. The upper bound on the expected reward of this route may be expressed as the following formula:

$${R}_{upper} ( \{ {i}_{1} , {i}_{2} , … , {i}_{M} \} , \{ {park}_{1} , {park}_{2} , … , {park}_{M} \} ) = {R}_{lower} ( \{ {i}_{1} , {i}_{2} , … , {i}_{M} \} , \{ {park}_{1} , {park}_{2} , … , {park}_{M} \} ) + R ( {T}_{d} ( \{ {i}_{1} , {i}_{2} , … , {i}_{M} \} ) + {T}_{d} ( {i}_{M} , destination ) ) \cdot {\prod }_{m = 1}^{M} ( 1 - p ( {i}_{m} ) \cdot {park}_{m} ) \qquad ( Equation 2 )$$

where T_{d}(i_{M},destination) is defined as the shortest time it may take the car to reach the destination from road segment with ID i_{M}. The upper bound in Equation 2 assumes that if there are no available parking spots along the first M segments of the route, the car will be able to drive directly to the destination in time T_{d} (i_{M}, destination) and find a parking spot there with probability 1, thus getting the reward R(T_{d}({i₁, i₂, . . . , i_{M}})+T_{d}(i_{M},destination)). Both lower and upper bounds approach the actual expected reward as M gets large.

In the preferred embodiment, the system selects the recommended parking search route as the route with the highest expected reward. One way to find such route is to perform an exhaustive search of all possible routes of length M and all possible combinations of PARK and NO_PARK indicators assigned to segments along each route. If M is large enough, either or both the lower bounds equation (Equation 1) and the upper bounds equation (Equation 2) might be appropriate equations for the system to use. Since the number of possible routes is expected to grow exponentially with route length M, the computational cost may be very large for a large M. As an alternative, the system may use more computationally efficient schemes for calculating the recommended route. For example, the system may use a greedy strategy that starts from all possible routes of length 2, where the first segment corresponds to the current car location and the second segment is any segment that could be reached next by the car if it continued driving along its current direction. The system may then calculate upper bounds (Equation 2) of all possible combinations of routes of length 2 {i₁,i₂} and their parking indicators {park₁,park₂}. The routes may be sorted based on their upper bounds and the route with the highest upper bound may be extended by one more segment. The procedure may be iterated until the route with the highest bound is of length M. Said route would be guaranteed to have the highest upper bound of all the routes of length M and there will be no need to further evaluate all possible routes of length M. Said route of length M may be selected as the recommended parking search route by recommendation engine 320.

The procedure described in the previous paragraphs is one preferred way of approaching this task. In alternative embodiments the recommended parking search route could be calculated in numerous other ways. In some embodiments, the driving and the walking times in Equations 1 and 2 may be treated as random variables. In some embodiments, upper and lower bounds on the expected reward may be defined differently from Equations 1 and 2 and the reward function may be defined in different ways to account for time flexibility, price elasticity, walking preferences, and any other factors that may be important for quantifying satisfaction of drivers with parking search routes. In some embodiments, it may be preferable for computational reasons to calculate sub-optimal routes that do not necessarily provide the highest expected reward, for example, by using various fast search heuristics. It may also be possible to evaluate the routes without having to calculate the expected reward, for example, by using appropriate heuristically-based formulas for the reward. In some embodiments, the recommended parking search route might be determined without having to search for a route with a high reward, for example, by simulating how informed humans would select the route, or by analyzing how actual successful drivers search for parking. In some embodiments, even routes determined by random walks through the road network or based on any type of an informed guess may be used.

It is to be understood that the preferred embodiment may provide recommendations for segments containing either on-street or off-street parking spots. The main difference between these two types of parking spots is pricing, which could be accounted for through the reward function. The recommendations could also be provided if segments contain mixed types of parking spots, such as free on-street and paid off-street parking spots. Parking recommendation engine 320 can account for a mixed-type segment by treating the segment as a concatenation of several subsegments, each with a single parking type.

In an embodiment, parking probabilities and traffic speed can also be calculated and incorporated into the reward equations. Information about outcomes of parking searches of users of the system may be used to estimate parking probability and traffic speed along visited segments and segments in vicinity of the visited segments. An example embodiment of how this may be done is described in this section. In this preferred embodiment, client device 110 may use its location sensing component 220 to track locations of car 120 as it follows its recommended route. Client device 110 may send said time-stamped locations to remote server 130, and the received time-stamped locations may be stored in database 330 together with the recommended route. In this way, database 330 may contain information about all previous parking searches of users of the system. This information may be analyzed using various statistical methods to predict current or future traffic speed and parking probabilities in vicinity of the previously visited road segments. To illustrate a simple way how the predictions may be calculated, let us assume that database 330 contains only one parking search of the user from the example shown in FIG. 6. Let us also assume the user followed the route and found parking on segment 514 one minute ago and that recommendation engine 320 wants to estimate the current parking probabilities. By studying the time-stamped locations recorded during this particular parking search, recommendation engine 320 may conclude that there are no available parking spots on segment 513 and that there may be more available parking spots on segment 514. Thus, recommendation engine 320 may estimate current parking probabilities on segments 513 and 514 in the following way: it may assign a low parking probability, for example 0.1, for segment 513 and a high parking probability, for example 0.8, for segment 514. Furthermore, recommendation engine 320 may estimate current driving speed along segments 511 to 514, for example to be equal to the speed observed from the moving trajectory.

In practice, database 330 may contain a number of previously observed parking search trajectories and recommendation engine 320 may use more sophisticated methods to estimate parking probabilities and traffic speed. These methods may be able to exploit spatial correlations, temporal correlations, and traffic and parking regularities. Spatial correlations correspond to an assumption that neighboring segments may have similar parking probability and similar traffic speed. Temporal correlations correspond to an assumption that parking probabilities and traffic speed do not change abruptly in time. Traffic and parking regularities may correspond to repetitive nature of traffic and parking behavior, for example, where parking availability tends to be similar at the same time of a day or during a given day of the week or during a particular kind of event.

In addition to data about previous parking searches of the users of the system stored in database 330, recommendation engine 320 may use information obtained from third-party servers, for example, traffic speed obtained from public sources or from commercial services, occupancy of on-street parking spots measured by parking sensor systems, occupancy in public or private garages measured by garage sensor systems, and traffic speed and parking spot occupancy collected through crowdsourcing. Recommendation engine 320 may apply an appropriate statistical method to use the available traffic and parking data for estimation of current or prediction of future parking probabilities and traffic speed over multiple road segments.

In the following, we give an example of a system that may be developed using the described preferred embodiment. In this system, client device 110 may be a smart phone with an installed parking search app. Upon opening the app, the driver may be asked to press a single button called “Park Here” and enter desired the parking duration. The client device then records current location of car 120 and sends it to server 130.

Recommendation engine 320 receives the location and queries database 330 to obtain all segments of the road network, the traffic rules and the parking rules within 2 kilometers of the received location. Recommendation engine 320 assumes that the received location is both the current location of car 120 and its destination and assumes that the reward function is the one depicted at the bottom of FIG. 8. Recommendation engine 320 also assumes that along all the retrieved road segments the driving speed equals 20 km/hour. It also assumes that along all the segments the parking probability equals 0.8, reflecting a belief that a chance of finding a parking spot is equal at any segment and reasonably high. In addition, it assumes that the walking speed is 3 km/hour. Depending on the desired parking duration, some road segments may not be available for parking. For example, if the desired parking duration is 3 hours, the system could automatically assign NO_PARK labels to all road segments on which parking duration is restricted to less than 3 hours. Using Equation 2, recommendation engine 320 finds the route of length M=10 and the PARK/NO_PARK labeling of its segments that have the highest expected reward. Remote server 130 sends the route to client device 110, which then displays the route overlayed on a road map.

In this system, user interaction with the app on client device 110 is very simple and recommendation engine 320 does not require sophisticated knowledge of traffic conditions and parking probabilities. As a consequence, the quality of the recommended parking search route might not be high. However, the recommended route might still be considerably better than a parking search route of an uninformed driver, at the least thanks to use of the knowledge about the parking rules in the vicinity of the destination.

In the following, we give an example of a more sophisticated system that may be developed using the described preferred embodiment. In this system, client device 110 is a smart phone with an installed parking search app. Upon opening the app, the driver is offered to select the destination, enter the desired parking duration, price elasticity, time flexibility, and walking preference. After the driver enters the parking instructions, client device 110 records current location and driving direction of car 120 and sends it together with information entered by the driver to server 130.

Recommendation engine 320 on remote server 130 receives the parking instructions. It queries database 330 to obtain the road network, the traffic rules, and the parking rules within 2 kilometers of the destination. Using parking preferences entered by the driver, it determines an appropriate reward function. It also obtains from database 330 or from third-party servers 350 information based on which it estimates parking probabilities and traffic speed along road segments within the retrieved fraction of the road network. Similarly to the system described previously, some road segments may be automatically labeled as NO_PARK depending on the desired parking duration. The system may also estimate based on the previous parking searches of the particular driver the walking speed of the driver. It may also estimate based on the previous users who parked at a specific parking spot the time needed to pay for parking and leave the parking facility.

If the current location of car 120 is close to the destination, for example within 1 kilometer, recommendation engine 320 may use Equation 2 to find the best route of desired length, for example M=10. If the current location of car 120 is far from the destination, for example more than 1 kilometer away, recommendation engine 320 could first instruct car 120 to follow the shortest path to the destination and calculate the recommended parking search route only when car 120 is within 1 kilometer of the destination.

Remote server 130 sends the route to client device 110, which then displays the route and route segment labeling overlaid on a road map. Remote server 130 could also send information about the parking probabilities and traffic speed in the vicinity of the destination, the expected reward of the recommended route, the expected monetary cost of parking when following the recommended route, or some other information, for example, the expected time to reach the destination if free parking is requested or if parking fee up to 20 dollars is paid. In this more sophisticated system, the quality of the recommended parking search route would increase with the quality of traffic and parking information.

The exemplary embodiment of the system described above assumed the client-server system depicted in FIG. 1, where the client device is available to the driver and calculation of the parking search path is performed on a remote server. The present invention is not limited to such setup. For example, embodiments are possible where the recommendation engine is within the client device and where the client device may have access to information such as road network, traffic rules, and parking rules on its local database and where data such as current traffic speed and current parking probabilities are available from a remote database. In other embodiments, the client device may not be in the car. For example, the client device might be a desktop computer and interaction with a user might be through a web site accessed through the desktop computer. The user might be a friend of the driver who requests the parking search route and communicates it to the driver by phone. To remove the concern about physical location of the recommendation engine and the database, one embodiment of the system may be described as a recommendation engine that receives parking instructions and parking information, calculates the recommended parking search route, and reports the route.

In the exemplary embodiment above, it was assumed that the parking search route is requested for an actual car from its current location. In other embodiments, the system may also accept requests for parking at some future time. The same approach for parking route recommendation as described above in the exemplary embodiment may be used for future predictions, with the only difference that predicted traffic speed and parking probabilities might be less reliable. Recommendations for parking search routes at a future time might be useful, for example, in cases when the driver anticipates a loss of connection with the recommendation engine and wants to print out the route prior to departure. A more relevant justification might be that the driver is interested in time and expected monetary costs of parking at a certain time of the day to help in trip planning. In some embodiments, the system may provide expected parking times or parking rewards for locations within a specified spatial region and at any time during a day or during a week.

In the embodiments mentioned so far, it was assumed that the parking search route is used by a human vehicle operator. The present invention allows for embodiments where a vehicle is driven by driving software. As a result, in some embodiments, the recommended parking search route may be presented to the driving software in an appropriate data format and the driving software may be instructed to find the first available parking spot, potentially aided by parking spot detection sensors installed in the car or with help from human car passengers. One potential scenario might be that a car with the driving software first drives directly to the destination, unloads the passengers, and then begins searching for a parking spot using the parking recommendation system. The reward function in this case may be more sensitive to the monetary cost of parking than to the parking search time or distance to the destination.

The present invention may be applicable beyond the problem of finding parking for vehicles on road networks. In general, it may be applicable to any setup where independent agents are looking for a resource within a network and where information about availability or status of the resource is uncertain.

While various embodiments of the present invention have been described above, it should be understood that they have been presented by way of example only, and not limitation. It will be apparent to persons skilled in the art that various changes in form and detail can be made therein without departing from the spirit and scope of the invention. Thus, the breadth and scope of the present invention should not be limited by any of the above-described exemplary embodiments, but should be defined in accordance with the following claims and their equivalents.

What is claimed is:

1. A method in a computer system for recommending a parking search route, comprising:
receiving parking instructions for a vehicle;
receiving parking information for a parking region, the parking information for creating a parking search route for said vehicle;
processing said parking instructions and said parking information to create a parking search route, wherein said parking search route comprises a plurality of segments, wherein each of the plurality of segments comprises a parking indicator, wherein the parking indicator indicates whether parking should be sought along the segment; and
reporting said parking search route; wherein said vehicle is instructed to follow said parking search route and to park at a first available parking spot along said plurality of segments which comprise parking indicators indicating that parking should be sought along the segment.

2. The method of claim 1, wherein the parking instructions comprise one or more of:
a start time for the parking route search;
a current location of the vehicle;
a destination location;
a parking duration; and
a parking preference for the vehicle.

3. The method of claim 2, wherein the parking preference comprises one or more of:
a preferred parking duration;
an indication of parking flexibility;
an indication of price elasticity; and
an indication of walking flexibility.

4. The method of claim 1, wherein the parking information comprises one or more of:
road network information for the parking region;
parking rules for the parking region;
traffic rules for the parking region;
traffic speed information for the parking region; and
parking probabilities for the parking region.

5. The method of claim 1, wherein the parking instructions are received by a client device, and the processing is performed by a remote server, further comprising submitting via a communications link said parking instructions from the client device to the remote server, and sending via the communications link said parking search route from said remote server to said client device.

6. The method of claim 5, further comprising:
receiving at the remote server a plurality of parking search trajectories from a plurality of users; and
processing said plurality of parking search trajectories to estimate a traffic speed for said parking region.

7. The method of claim 6, wherein the traffic speed is estimated for a specified time.

8. The method of claim 6, wherein the traffic speed is estimated for each of the plurality of segments.

9. The method of claim 5, further comprising:
receiving at the remote server a plurality of parking search trajectories from a plurality of users; and
processing said plurality of parking search trajectories to estimate a parking probability for said parking region.

10. The method of claim 9, wherein the parking probability is estimated for a specified time.

11. The method of claim 9, wherein the parking probability is estimated for each of the plurality of segments.

12. The method of claim 5, further comprising:
receiving at the remote server a plurality of moving trajectories from a plurality of users, each moving trajectory comprising a trajectory followed by the user from a parking spot to a destination and an elapsed time period for the user to travel along the trajectory;
Processing said plurality of moving trajectories to estimate a travel time for a user of the vehicle to travel from the parking spot to a destination.

13. The method of claim 5, further comprising
receiving at the remote server information about weather conditions for the parking region; and
processing said weather condition information to refine said parking search route.

14. The method of claim 5, further comprising:
receiving at the remote server information about a limited-duration event occurring within the parking region; and
processing said limited-duration event to refine said parking search route.

15. The method of claim 14, wherein said limited-duration event comprises an event that reduces availability of parking within a segment of the parking region.

16. The method of claim 14, wherein said limited-duration event comprises an event that decreases traffic speed within a segment of the parking region.

17. A storage medium storing a parking search route, the parking search route comprising:
a plurality of consecutive road segments, including a starting location for a vehicle;
wherein each segment contains an indication of whether the segment is designated for parking; and
wherein said parking search route instructs said vehicle to follow said parking search route and park at a first available parking spot along said segments of said parking search route which are designated for parking.

18. A computer system for recommending a parking search route, comprising:
a data storage configured to receive parking instructions for a vehicle, and parking information for a parking region, said parking information being used for creating a parking search route for said vehicle;
a recommendation engine operatively connected to the data storage, configured to retrieve and process said parking instructions and said parking information to create a parking search route, wherein said parking search route comprises a plurality of segments, wherein each of the plurality of segments comprises a parking indicator, wherein the parking indicator indicates whether parking should be sought along the segment; and
a route reporting engine, operatively connected to the recommendation engine, configured to receive said parking search route from said recommendation engine and report said parking search route; wherein said vehicle is instructed to follow said parking search route and to park at a first available parking spot along said plurality of segments which comprise parking indicators indicating that parking should be sought along the segment.

19. The system of claim 18, wherein the parking instructions comprise one or more of:
a start time for the parking route search;
a current location of the vehicle;
a destination location;
a parking duration; and
a parking preference for the vehicle.

20. The system of claim 19, wherein the parking preference comprises one or more of:
a preferred parking duration;
an indication of parking flexibility;
an indication of price elasticity; and
an indication of walking flexibility.

21. The system of claim 18, wherein the parking information comprises one or more of:
road network information for the parking region;
parking rules for the parking region;
traffic rules for the parking region;
traffic speed information for the parking region; and
parking probabilities for the parking region.

22. The system of claim 18, further comprising:
a client device configured to:
receive said parking instructions from a user and transmit said parking instructions to said data storage; and
receive said parking search route from said route reporting engine.

23. The system of claim 22, wherein the client device comprises:
an input receiver configured to receive said parking instructions from a user of said vehicle;
a communications link configured to transmit said parking instructions and receive said parking search route;
a display configured to display said parking search route; and
a speaker configured to provide audio guidance for said parking search route.

24. The system of claim 18, wherein said route reporting engine is further configured to report one or more of:
road network information;
parking rules;
an estimated traffic speed for said parking region;
estimated parking probabilities for said parking region;
an estimated time to locate the parking spot;
an estimated time to a destination; and
an estimated cost to park in the parking spot.

25. The system of claim 18, wherein the data storage is further configured to receive and store a plurality of parking search trajectories from a plurality of users; and wherein the recommendations engine is further configured to process said plurality of parking search trajectories to estimate a traffic speed for said parking region.

26. The system of claim 25, wherein the traffic speed is estimated for a specified time.

27. The system of claim 25, wherein the traffic speed is estimated for each of the plurality of segments.

28. The system of claim 18, wherein the data storage is further configured to receive and store a plurality of parking search trajectories from a plurality of users; and wherein the recommendations engine is further configured to process said plurality of parking search trajectories to estimate a parking probability for said parking region.

29. The system of claim 28, wherein the parking probability is estimated for a specified time.

30. The system of claim 28, wherein the parking probability is estimated for each of the plurality of segments.

31. The system of claim 18, wherein the data storage is further configured to receive and store a plurality of moving trajectories from a plurality of users, each moving trajectory comprising a trajectory followed by the user from a parking spot to a destination and an elapsed time period for the user to travel along the trajectory; and wherein the recommendations engine is further configured to process said plurality of moving trajectories to estimate a travel time for a user of the vehicle to travel from the parking spot to a destination.

32. The system of claim 18, wherein the recommendations engine is further configured to receive information about weather conditions for the parking region and process said weather condition information to refine said parking search route.

33. The system of claim 18, wherein the recommendations engine is further configured to receive information about a limited-duration event occurring within the parking region; and
process said limited-duration event to refine said parking search route.

34. The system of claim 33, wherein said limited-duration event comprises an event that reduces availability of parking within a segment of the parking region.

35. The system of claim 33, wherein said limited-duration event comprises an event that decreases traffic speed within a segment of the parking region.
